(19) United States
(12) Patent Application Publication
(10) Pub. No.: US 2025/0271801 A1
(43) Pub. Date: Aug. 28, 2025

(54) IMAGE FORMING APPARATUS, IMAGE FORMING METHOD

(71) Applicant: KYOCERA Document Solutions Inc., Osaka (JP)

(72) Inventors: Yasuaki Sakamoto, Osaka (JP); Masaru Watanabe, Osaka (JP); Ayato Morikami, Osaka (JP); Makoto Matsumoto, Osaka (JP); Yukiko Kotani, Osaka (JP); Atsuki Ito, Osaka (JP)

(21) Appl. No.: 19/063,866

(22) Filed: Feb. 26, 2025

(30) Foreign Application Priority Data
Feb. 28, 2024 (JP) 2024-028667

(51) Int. Cl. G03G 15/00; G06K 15/02; G06K 15/14

(52) U.S. Cl. CPC G03G 15/5058; G06K 15/14; G06K 15/1856

(57) ABSTRACT

An image forming apparatus includes an image forming portion, a first image processing portion, and a second image processing portion. The second image processing portion, when a predetermined execution condition is satisfied, executes a detection image forming process in which a detection image that is used for adjusting an image forming condition in the image forming portion, is formed by the image forming portion in an area outside a print area on a transfer object. In a case where, after the detection image forming process is started during execution of a normal image forming process, the normal image forming process ends before the detection image forming process ends, the second image processing portion switches between continuing and not continuing the detection image forming process in accordance with a predetermined switch condition.

### INCORPORATION BY REFERENCE

This application is based upon and claims the benefit of priority from the corresponding Japanese Patent Application No. 2024-028667 filed on Feb. 28, 2024, the entire contents of which are incorporated herein by reference.

### BACKGROUND

The present disclosure relates to an image forming apparatus and an image forming method.

An electrophotographic image forming apparatus includes an image forming portion for forming an image on a transfer object based on input image data. In addition, the image forming apparatus executes a normal image forming process in which a print image is formed on a transfer object by the image forming portion based on print target image data. In addition, the image forming apparatus may execute, during execution of the normal image forming process, a detection image forming process to form a detection toner image that is used for adjusting an image forming condition in the image forming portion.

### SUMMARY

An image forming apparatus according to an aspect of the present disclosure includes an image forming portion, a first image processing portion, and a second image processing portion. The image forming portion forms an image on a transfer object based on input image data. The first image processing portion executes a normal image forming process in which a print image is formed in a predetermined print area on the transfer object by the image forming portion based on print target image data. The second image processing portion, when a predetermined execution condition is satisfied, executes a detection image forming process in which a detection image that is used for adjusting an image forming condition in the image forming portion, is formed by the image forming portion in an area outside the print area on the transfer object. In addition, in a case where, after the detection image forming process is started during execution of the normal image forming process, the normal image forming process ends before the detection image forming process ends, the second image processing portion switches between continuing and not continuing the detection image forming process in accordance with a predetermined switch condition.

An image forming method according to another aspect of the present disclosure is executed by a processor of an image forming apparatus including an image forming portion configured to form an image on a transfer object based on input image data. In the image forming method, a first image processing step and a second image processing step are executed. The first image processing step executes a normal image forming process in which a print image is formed in a predetermined print area on the transfer object by the image forming portion based on print target image data. The second image processing step, when a predetermined execution condition is satisfied, executes a detection image forming process in which a detection image that is used for adjusting an image forming condition in the image forming portion, is formed by the image forming portion in an area outside the print area on the transfer object. In addition, in the second image processing step, in a case where, after the detection image forming process is started during execution of the normal image forming process, the normal image forming process ends before the detection image forming process ends, switching is made between continuing and not continuing the detection image forming process in accordance with a predetermined switch condition.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross section diagram showing a configuration of an image forming apparatus according to an embodiment of the present disclosure.

FIG. 2 is a block diagram showing a system configuration of the image forming apparatus according to the embodiment of the present disclosure.

FIG. 3 is a schematic diagram showing a configuration of an image forming portion of the image forming apparatus according to the embodiment of the present disclosure.

FIG. 4 is a bottom diagram showing a configuration of an intermediate transfer belt of the image forming apparatus according to the embodiment of the present disclosure.

FIG. 5 is a diagram schematically showing an example of a detection toner image formed on the intermediate transfer belt in an image forming apparatus according to a first embodiment of the present disclosure.

FIG. 6 is a flowchart showing an example of a condition adjustment process executed in the image forming apparatus according to the first embodiment of the present disclosure.

FIG. 7 is a flowchart showing an example of a condition adjustment process executed in an image forming apparatus according to a second embodiment of the present disclosure.

FIG. 8 is a diagram schematically showing an example of the detection toner image formed on the intermediate transfer belt in the image forming apparatus according to the second embodiment of the present disclosure.

FIG. 9 is a flowchart showing an example of a condition adjustment process executed in an image forming apparatus according to a third embodiment of the present disclosure.

FIG. 10 is a diagram schematically showing an example of the detection toner image formed on the intermediate transfer belt in the image forming apparatus according to the third embodiment of the present disclosure.

### DETAILED DESCRIPTION

The following describes embodiments of the present disclosure with reference to the accompanying drawings. It should be noted that the following embodiments are examples of specific embodiments of the present disclosure and should not limit the technical scope of the present disclosure.

### First Embodiment

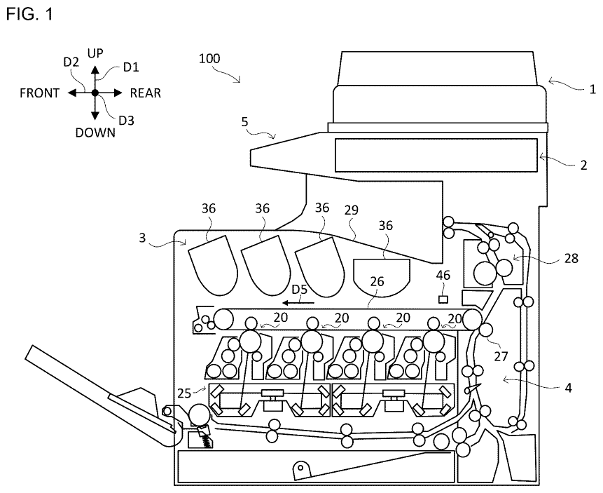

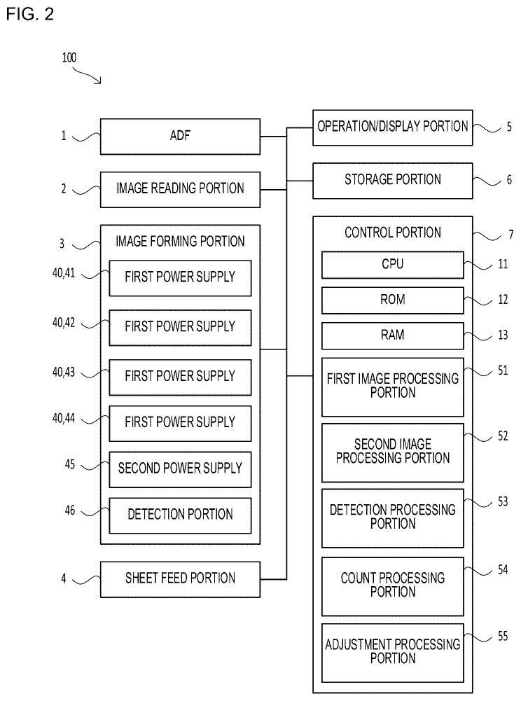

First, a configuration of an image forming apparatus 100 according to a first embodiment of the present disclosure is described with reference to FIG. 1 and FIG. 2.

It is noted that for the sake of explanation, an up-down direction D1 is defined as a vertical direction in a state where the image forming apparatus 100 is installed usably (the state shown in FIG. 1). In addition, a front-rear direction D2 is defined on the supposition that the left-side surface of the image forming apparatus 100 shown in FIG. 1 is a front side (front). Furthermore, a left-right direction D3 is defined based on the image forming apparatus 100 in the installation state viewed from the front side.

The image forming apparatus 100 is a multifunction peripheral having a plurality of functions such as a scan function for reading an image of a document sheet, a print function for forming an image based on image data, a facsimile function, and a copy function. It is noted that the present disclosure is applicable to image forming apparatuses, such as a printer, a facsimile device, and a copier, that can form an image by an electrophotographic method.

As shown in FIG. 1 and FIG. 2, the image forming apparatus 100 includes an ADF (Auto Document Feeder) 1, an image reading portion 2, an image forming portion 3, a sheet feed portion 4, an operation/display portion 5, a storage portion 6, and a control portion 7.

The ADF 1 conveys a document sheet that is a reading target to be read by the scan function. The ADF 1 includes a document sheet setting portion, a plurality of conveyance rollers, a document sheet pressing member, and a sheet discharge portion.

The image reading portion 2 realizes the scan function. The image reading portion 2 includes a document sheet table, a light source, a plurality of mirrors, an optical lens, and a CCD (Charge Coupled Device).

The image forming portion 3 realizes the print function. Specifically, the image forming portion 3 forms a color or monochrome image on a sheet supplied from the sheet feed portion 4 by an electrophotographic method.

The sheet feed portion 4 supplies a sheet to the image forming portion 3. The sheet feed portion 4 includes a sheet feed cassette, a manual feed tray, and a plurality of conveyance rollers. It is noted that the control portion 7 can preliminarily set the sheet type of the print target sheet stored in the sheet feed cassette, in accordance with a user operation. In particular, when the sheet feed portion 4 includes a plurality of sheet feed cassettes, it is possible to set the sheet type for each of the plurality of sheet feed cassettes.

The operation/display portion 5 is a user interface of the image forming apparatus 100. The operation/display portion 5 includes a display portion and an operation portion, wherein the display portion, such as a liquid crystal display, is configured to display a variety of information in response to control instructions from the control portion 7, and the operation portion, such as operation keys or a touch panel, is configured to input a variety of information to the control portion 7 in response to user operations.

The storage portion 6 is a nonvolatile storage device. For example, the storage portion 6 is a nonvolatile memory such as a flash memory. It is noted that the storage portion 6 may be a SSD (Solid State Drive) or a HDD (Hard Disk Drive).

The control portion 7 comprehensively controls the image forming apparatus 100. As shown in FIG. 2, the control portion 7 includes a CPU 11, a ROM 12, and a RAM 13. The CPU 11 includes one or more processors that execute various types of calculation processes. The ROM 12 is a nonvolatile storage device in which are preliminarily stored various types of information such as control programs for causing the CPU 11 to execute various processes. The RAM 13 is a volatile or nonvolatile storage device that is used as a temporary storage memory (working area) for the various types of processes executed by the CPU 11. The CPU 11 comprehensively controls the image forming apparatus 100 by executing the various types of control programs that are preliminarily stored in the ROM 12.

It is noted that the control portion 7 may be a control portion that is provided separately from a main control portion that comprehensively controls the image forming apparatus 100. In addition, the control portion 7 may be composed of an electronic circuit such as an integrated circuit (ASIC)

### Configuration of Image Forming Portion 3

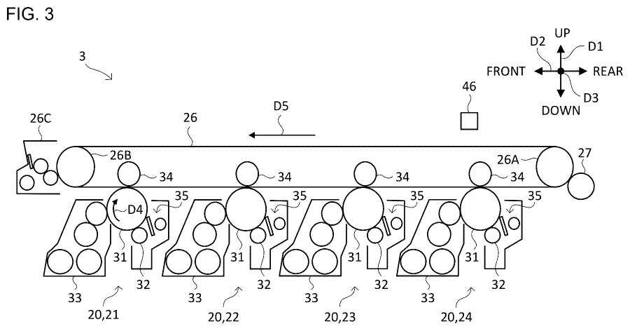

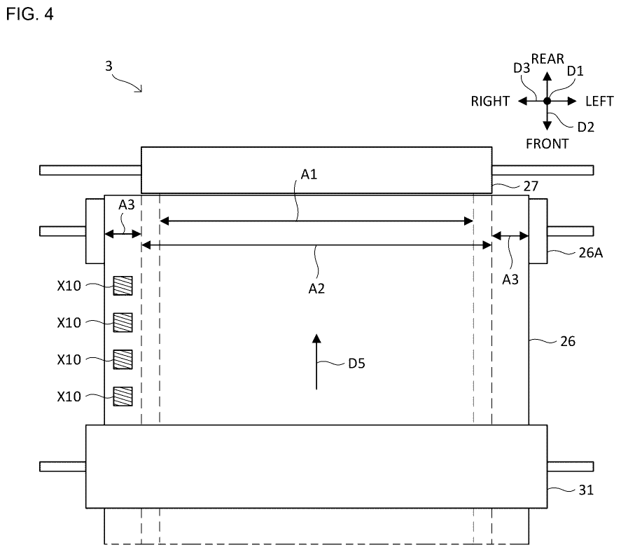

Next, with reference to FIG. 1 to FIG. 4, a configuration of the image forming portion 3 is described. Here, FIG. 3 is a schematic diagram showing a configuration of a plurality of image forming units 20, an intermediate transfer belt 26, and a secondary transfer roller 27. In addition, FIG. 4 is a bottom diagram showing a configuration of a photoconductor drum 31 of an image forming unit 24, the intermediate transfer belt 26, a drive roller 26A, and the secondary transfer roller 27.

As shown in FIG. 1, the image forming portion 3 includes four image forming units 20, an optical scan device 25, the intermediate transfer belt 26, the secondary transfer roller 27, a fixing device 28, and a sheet discharge tray 29. In addition, as shown in FIG. 2 and FIG. 3, the image forming portion 3 includes four first power supplies 40, a second power supply 45, and a detection portion 46. In addition, the image forming portion 3 forms a toner image based on input image data on the intermediate transfer belt 26 and transfers the toner image from the intermediate transfer belt 26 to the sheet.

The four image forming units 20 include image forming units 21 to 24. The image forming unit 21 (see FIG. 3) forms a Y (yellow) toner image. The image forming unit 22 (see FIG. 3) forms a C (cyan) toner image. The image forming unit 23 (see FIG. 3) forms a M (magenta) toner image. The image forming unit 24 (see FIG. 3) forms a K (black) toner image. As shown in FIG. 1 and FIG. 3, the four image forming units 20 are aligned along the front-rear direction D2 in the order of yellow, cyan, magenta, and black from the front side of the image forming apparatus 100.

As shown in FIG. 3, each of the image forming units 20 includes a photoconductor drum 31, a charging roller 32, a developing device 33, a primary transfer roller 34, and a drum cleaning portion 35. In addition, each of the image forming units 20 includes a toner container 36 shown in FIG. 1.

On the surface of the photoconductor drum 31, an electrostatic latent image is formed. For example, the photoconductor drum 31 includes a photosensitive layer formed from amorphous silicon. Upon receiving a rotational driving force supplied from a motor (not shown), the photoconductor drum 31 rotates in a drum rotation direction D4 shown in FIG. 3. This allows the photoconductor drum 31 to convey the electrostatic latent image formed on its surface.

The charging roller 32 electrically charges the surface of the photoconductor drum 31 upon receiving an application of a predetermined charging voltage. For example, the charging roller 32 electrically charges the surface of the photoconductor drum 31 to a positive polarity. The optical scan device 25 irradiates light based on image data to the surface of the photoconductor drum 31 that has been electrically charged by the charging roller 32. This forms an electrostatic latent image on the surface of the photoconductor drum 31.

The developing device 33 develops the electrostatic latent image formed on the surface of the photoconductor drum 31. The developing device 33 includes a pair of stirring members, a magnet roller, and a developing roller. The pair of stirring members stir developer stored in the developing device 33, wherein the developer includes toner and carrier. For example, the toner included in the developer is charged with positive polarity by friction with the carrier included in the developer. The magnet roller draws up the developer stirred by the pair of stirring members and supplies the toner included in the developer to the developing roller. The developing roller conveys the toner supplied from the magnet roller to a position facing the photoconductor drum 31. In addition, upon receiving an application of a predetermined developing bias voltage, the developing roller supplies the toner conveyed to the position facing the photoconductor drum 31, to the photoconductor drum 31. This allows the toner to be selectively supplied to an exposure area of the photoconductor drum 31 to which the light has been irradiated by the optical scan device 25, so that the electrostatic latent image formed on the surface of the photoconductor drum 31 is developed. It is noted that the developing device 33 receives a supply of the toner from the toner container 36.

The primary transfer roller 34, upon receiving a supply of a predetermined primary transfer current, transfers a toner image formed on the surface of the photoconductor drum 31 to an outer peripheral surface of the intermediate transfer belt 26. As shown in FIG. 3, the primary transfer roller 34 is disposed to face the photoconductor drum 31 across the intermediate transfer belt 26. It is noted that the intermediate transfer belt 26 is an example of a transfer object of the present disclosure.

The drum cleaning portion 35 removes the toner that has remained on the surface of the photoconductor drum 31 after the toner image transfer performed by the primary transfer roller 34.

The optical scan device 25 emits light based on the image data, to the surface of the photoconductor drum 31 of each of the image forming units 20.

The intermediate transfer belt 26 is a belt member of an endless shape to which a toner image formed on the surface of the photoconductor drum 31 of each of the image forming units 20 is transferred. For example, the intermediate transfer belt 26 is formed from a resin material such as polyimide. The intermediate transfer belt 26 is stretched by the drive roller 26A (see FIG. 3) and a stretch roller 26B (see FIG. 3) with a predetermined tension. The intermediate transfer belt 26 rotates in a belt rotation direction D5 shown in FIG. 3 when the drive roller 26A rotates upon receiving a rotational driving force supplied from a motor (not shown). This allows the intermediate transfer belt 26 to convey the toner image transferred from each of the photoconductor drums 31, to a transfer position where the toner image is transferred to a sheet by the secondary transfer roller 27. It is noted that the outer peripheral surface of the intermediate transfer belt 26 from which the toner image has been transferred by the secondary transfer roller 27 is cleaned by a belt cleaning portion 26C (see FIG. 3).

The secondary transfer roller 27, upon receiving a supply of a predetermined secondary transfer current, transfers the toner image that has been transferred to the outer peripheral surface of the intermediate transfer belt 26, to a sheet supplied from the sheet feed portion 4. As shown in FIG. 3, the secondary transfer roller 27 is disposed to face the drive roller 26A across the intermediate transfer belt 26.

As shown in FIG. 4, the size of the secondary transfer roller 27 in the axis direction (the left-right direction D3) is smaller than the width of the intermediate transfer belt 26 (the size in the left-right direction D3). As a result, the outer peripheral surface of the intermediate transfer belt 26 has a non-contact area A3 (see FIG. 4) that does not come in contact with the secondary transfer roller 27. The non-contact area A3 is an area outside a contact area A2 (see FIG. 4) of the outer peripheral surface of the intermediate transfer belt 26 that comes in contact with the secondary transfer roller 27, and the non-contact area A3 includes an end portion of the intermediate transfer belt 26 in the width direction.

The fixing device 28 fixes the toner image transferred to the sheet by the secondary transfer roller 27, to the sheet.

The sheet to which the toner image has been fixed by the fixing device 28 is discharged to the sheet discharge tray 29.

Among the four first power supplies 40, a first power supply 41 (see FIG. 2) is a constant current power supply that supplies the primary transfer current to the primary transfer roller 34 of the image forming unit 21. Among the four first power supplies 40, a first power supply 42 (see FIG. 2) is a constant current power supply that supplies the primary transfer current to the primary transfer roller 34 of the image forming unit 22. Among the four first power supplies 40, a first power supply 43 (see FIG. 2) is a constant current power supply that supplies the primary transfer current to the primary transfer roller 34 of the image forming unit 23. Among the four first power supplies 40, a first power supply 44 (see FIG. 2) is a constant current power supply that supplies the primary transfer current to the primary transfer roller 34 of the image forming unit 24. The first power supplies 40 supply the primary transfer current set by the control portion 7 respectively to the primary transfer rollers 34. For example, the primary transfer current is a current of a negative polarity.

The second power supply 45 is a constant current power supply that supplies the secondary transfer current to the secondary transfer roller 27. The second power supply 45 supplies the secondary transfer current set by the control portion 7 to the secondary transfer roller 27. For example, the secondary transfer current is a current of a negative polarity.

The detection portion 46 is used to detect density and position of a toner image transferred to the non-contact area A3 (see FIG. 4) on the outer peripheral surface of the intermediate transfer belt 26. For example, the detection portion 46 is a photosensor of a reflection type including a light emitting portion and a light receiving portion, wherein the light emitting portion emits light toward the non-contact area A3 of the intermediate transfer belt 26, and the light receiving portion receives light that was emitted by the light emitting portion and was reflected from the non-contact area A3 of the intermediate transfer belt 26. The detection portion 46 inputs, to the control portion 7, an electric signal that corresponds to the density of a detection target toner image. It is noted that in the image forming apparatus 100, detection toner images described below may be formed on the non-contact areas A3 arranged on both sides of the contact area A2 in the intermediate transfer belt 26, and two detection portions 46 may be provided at positions where it is possible for them to detect the detection toner images formed on the non-contact areas A3 at both ends. In this case, in an adjustment process described below, an image forming condition is adjusted based on detection results of the two detection portions 46.

As shown in FIG. 3, the detection portion 46 is disposed downstream, in the belt rotation direction D5, of the transfer position where the toner image is transferred by the secondary transfer roller 27, and upstream, in the belt rotation direction D5, of a cleaning position where the outer peripheral surface of the intermediate transfer belt 26 is cleaned by the belt cleaning portion 26C. In addition, the detection portion 46 may be disposed downstream, in the belt rotation direction D5, of the photoconductor drum 31 of the image forming unit 24, and upstream, in the belt rotation direction D5, of the transfer position where the toner image is transferred by the secondary transfer roller 27.

### Configuration of Control Portion 7

Next, a configuration of the control portion 7 is described with reference to FIG. 2.

As shown in FIG. 2, the control portion 7 includes a first image processing portion 51, a second image processing portion 52, a detection processing portion 53, a count processing portion 54, and an adjustment processing portion 55. Specifically, a condition adjustment program for causing the CPU 11 to function as the above-described portions is preliminarily stored in the ROM 12 of the control portion 7. The CPU 11 functions as the above-described processing portions by executing the condition adjustment program stored in the ROM 12.

It is noted that the condition adjustment program may be recorded on a non-transitory computer-readable recording medium such as a CD, a DVD, or a flash memory, and may be read from the recording medium and installed in a storage device such as the storage portion 6. In addition, a part or all of the first image processing portion 51, the second image processing portion 52, the detection processing portion 53, the count processing portion 54, and the adjustment processing portion 55 may be composed of an electronic circuit such as an integrated circuit (ASIC).

The first image processing portion 51 executes a normal image forming process in which a print image based on print target image data is formed by the image forming portion 3 in a predetermined print area A1 (see FIG. 4) on the intermediate transfer belt 26. Specifically, the first image processing portion 51 controls the optical scan device 25 based on the print target image data to form electrostatic latent images corresponding to respective colors on the photoconductor drums 31 of the image forming units 20 at preset timings. Following this, in the image forming units 20, the electrostatic latent images formed on the photoconductor drums 31 are developed as toner images, and the toner images are transferred to the intermediate transfer belt 26 in sequence. After this, a color or monochrome image formed on the intermediate transfer belt 26 is transferred to a sheet by the secondary transfer roller 27, and the intermediate transfer belt 26 is cleaned by the belt cleaning portion 26C.

It is noted that in the normal image forming process, the first image processing portion 51 controls the light amount of laser light emitted from the optical scan device 25 based on predetermined input/output characteristics and the image data. In addition, in the normal image forming process, the first image processing portion 51 controls the developing bias voltage in each of the image forming units 20 to a value that is preliminarily set for each of the image forming units 20. Furthermore, in the normal image forming process, the first image processing portion 51 controls the charging voltage and the primary transfer current in each of the image forming units 20 and the secondary transfer current of the secondary transfer roller 27.

In addition, in the normal image forming process, the first image processing portion 51 controls the conveyance speed (hereinafter referred to as “linear speed”) of the intermediate transfer belt 26 to a speed that is preliminarily set for each of the print types (monochrome print, color print) depending on a sheet type (normal paper, thick paper, etc.) and the print type. For example, the first image processing portion 51 makes the linear speed slower when the sheet type is thick paper than when the sheet type is normal paper. In addition, the first image processing portion 51 makes the linear speed slower when the print type is color than when the print type is monochrome.

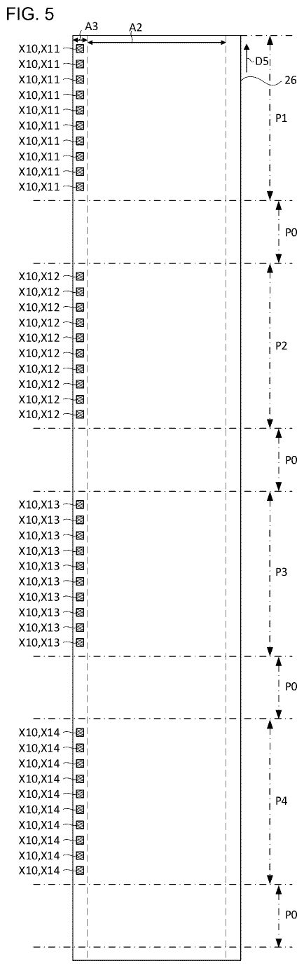

In addition, in the normal image forming process, the first image processing portion 51 executes a predetermined inter-sheet process during an inter-sheet period P0 (see FIG. 5) between a process for forming an image based on one page of image data on the intermediate transfer belt 26 and a process for forming an image based on next one page of image data on the intermediate transfer belt 26. For example, in the inter-sheet process, cleaning of the photoconductor drum 31 by the drum cleaning portion 35 or the like is executed. In addition, in the inter-sheet process, various types of image processing on image data corresponding to a next sheet in the normal image forming process may be executed.

The second image processing portion 52 executes a detection image forming process when a predetermined execution condition is satisfied. In the detection image forming process, detection toner images X10 (an example of a detection image) that are used for adjusting the image forming condition in the image forming portion 3, are formed by the image forming portion 3 in the non-contact area A3 (see FIG. 4) outside the print area A1 (see FIG. 4) of the intermediate transfer belt 26. The print area A1 is inside the contact area A2 (see FIG. 4) on the outer peripheral surface of the intermediate transfer belt 26. For example, the print area A1 is an area of the outer peripheral surface of the intermediate transfer belt 26 that comes in contact with a sheet of the largest size usable in the image forming apparatus 100.

It is noted that according to the present embodiment, the detection toner images X10 are formed on the non-contact area A3 (see FIG. 4). Therefore, compared to a configuration where the detection toner images X10 are formed on the contact area A2, there is no need to provide a cleaning portion that removes the detection toner images X10 that have adhered to the secondary transfer roller 27, from the secondary transfer roller 27. This makes it possible to simplify the configuration. On the other hand, the detection toner images X10 may be formed in an area that is outside the print area A1 (see FIG. 4) and inside the contact area A2 (see FIG. 4). In this case, however, the detection portion 46 is disposed downstream, in the belt rotation direction D5, of the photoconductor drum 31 of the image forming unit 24, and upstream, in the belt rotation direction D5, of the transfer position where the toner image is transferred by the secondary transfer roller 27.

In addition, the second image processing portion 52 forms in sequence, as the detection toner images X10, the detection toner images X11 to X14 that correspond to a plurality of colors respectively corresponding to the plurality of image forming units 20, on the intermediate transfer belt 26, based on predetermined detection image data corresponding to the plurality of colors. For example, the detection toner images X10 are single-color, rectangular images.

Specifically, as shown in FIG. 5, the second image processing portion 52 forms in sequence a plurality of detection toner images X11 corresponding to K (black), a plurality of detection toner images X12 corresponding to C (cyan), a plurality of detection toner images X13 corresponding to M (magenta), and a plurality of detection toner images X14 corresponding to Y (yellow). The detection toner images X11 are K (black) toner images corresponding to predetermined densities different from each other. Similarly, detection toner images X12 to X14 are C (cyan), M (magenta), and Y (yellow) toner images that respectively correspond to predetermined densities different from each other.

In addition, in the present embodiment, for the sake of explanation, a width in the belt rotation direction D5 required for forming a group of the plurality of detection toner images X11 is the same as a width of one page of print area P1 in print target image data. Similarly, with regard to the detection toner images X12 to X14, a width in the belt rotation direction D5 required for forming the detection toner images X12 to X14 is the same as a width of three pages of print areas P2 to P4 in the print target image data. In addition, in the detection image forming process, the detection toner images X10 are not formed during execution of the inter-sheet process. As a result, in the present embodiment, the number of pages required for forming all the detection toner images X11 to X14 on the intermediate transfer belt 26 is “4”. Accordingly, in a case where the detection image forming process is executed during execution of the normal image forming process, and the number of pages in the normal image forming process is “4” or less, the normal image forming process ends before the detection image forming process ends. It is noted that in another embodiment, a width in the belt rotation direction D5 required for forming the detection toner images X11 to X14 may exceed one page of print area in the print target image data.

In the present embodiment, the execution condition is that the accumulated number of prints printed in the image forming apparatus 100 has reached a multiple of a predetermined first reference number. In addition, the execution condition may be that the accumulated number of prints printed during execution of the normal image forming process has reached a multiple of a predetermined second reference number. In addition, the execution condition may be a timing that comes at predetermined time intervals.

The detection processing portion 53 uses the detection portion 46 to detect densities and positions of the detection toner images X10 formed in the non-contact area A3 of the intermediate transfer belt 26. It is noted that the detection processing portion 53 may detect either densities or positions of the detection toner images X10. For example, in a case where only a density correction process is executed in the adjustment process described below, only densities of the detection toner images X10 need to be detected, and in a case where only a position shift correction process is executed in the adjustment process, only positions of the detection toner images X10 need to be detected.

The count processing portion 54 executes a count process for counting the accumulated number of prints in the image forming apparatus 100. The accumulated number of prints counted in the count process is used to measure a timing for the adjustment processing portion 55 to execute the adjustment process. For example, the count processing portion 54 resets the count value to 0 (zero) each time the adjustment process is executed in the image forming apparatus 100. It is noted that the count processing portion 54 may count the accumulated number of prints for each of the print types such as color and monochrome.

The adjustment processing portion 55 executes the adjustment process for adjusting the image forming condition based on a detection result of the detection processing portion 53. Specifically, the adjustment processing portion 55 executes the density correction process, the position shift correction process and the like in the adjustment process.

In the density correction process, when a difference between the density of the detection toner image X10 detected by the detection processing portion 53 and a predetermined reference density is less than a predetermined threshold, the light amount of light emitted from the optical scan device 25 is adjusted, as the image forming condition, based on the difference. In addition, in the density correction process, when a difference between the density of the detection toner image X10 detected by the detection processing portion 53 and the reference density is equal to or more than the threshold, the developing bias voltage is adjusted, as the image forming condition, based on the difference. For example, the reference density is the density of the detection toner image X10 detected in the immediately preceding adjustment of the image forming condition. It is noted that the image forming condition adjusted in the density correction process is not limited to the light amount of light emitted from the optical scan device 25 and the developing bias voltage. For example, the image forming condition may include the input/output characteristics, the charging voltage, the primary transfer current, and the secondary transfer current.

In the position shift correction process, an image forming timing (a timing for the optical scan device 25 to emit light) of each of the image forming units 20 corresponding to the plurality of colors is adjusted based on a difference between a detection position of the detection toner image X10 detected by the detection processing portion 53 and a predetermined specific position.

Meanwhile, there may be a case where the number of prints corresponding to the print target image data is less than the number of prints required to form the detection toner images X10 on the intermediate transfer belt 26. In this case, if, for example, the detection image forming process is continued after completion of the normal image forming process, the image forming apparatus 100 needs to be driven while the normal image forming process is not executed. On the other hand, if the detection image forming process ends at the same time as when the normal image forming process ends, a timing for improving the image quality would be delayed. Concerning this problem, according to the image forming apparatus 100 of the present embodiment, it is possible to selectively achieve either suppressing driving of the image forming apparatus while the normal image forming process is not executed, or preventing the timing to improve the image quality from being delayed.

### Condition Adjustment Process

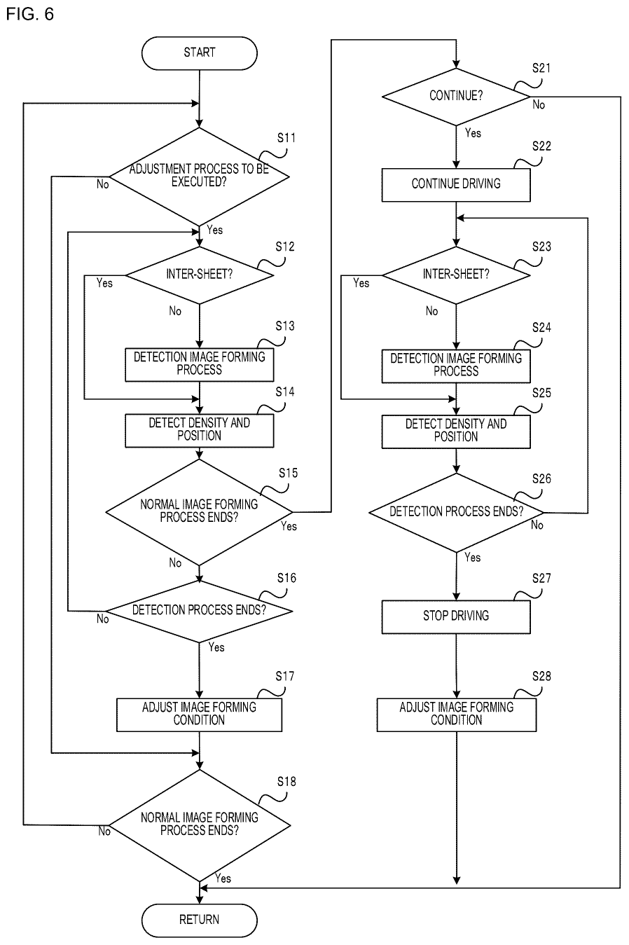

In the following, with reference to FIG. 6, a description is given of an example of the procedure of the condition adjustment process executed by the control portion 7 of the image forming apparatus 100, and an image forming method of the present disclosure. Here, steps S11, S12, . . . represent numbers assigned to the processing procedures (steps) executed by the control portion 7. It is noted that the condition adjustment process starts to be executed when the normal image forming process is executed to print a print image on a sheet based on the print target image data.

### Step S11

First, in step S11, the second image processing portion 52 of the control portion 7 determines whether or not a predetermined execution condition is satisfied. Specifically, the execution condition is that the accumulated number of prints printed in the image forming apparatus 100, counted by the count processing portion 54, has reached a multiple of a predetermined first reference number. For example, the first reference number is 100 or 200. Here, when it is determined that the execution condition is satisfied (S11: Yes), the process moves to step S12, and when it is determined that the execution condition is not satisfied (S11: No), the process moves to step S18.

### Step S12

In step S12, the control portion 7 determines whether or not it is within the inter-sheet period P0 in the normal image forming process. Here, when it is determined that it is within the inter-sheet period P0 (S12: Yes), the process moves to step S14, and when it is determined that it is not within the inter-sheet period P0 (S12: No), the process moves to step S13.

It is noted that the control portion 7 can determine that a timing to start the inter-sheet process has come when the optical scan device 25 had started emitting laser light based on one page of print target image data and has ended emitting the laser light based on the image data. In addition, the control portion 7 may determine that a timing to start the inter-sheet process has come when a predetermined time has passed since the optical scan device 25 started emitting laser light based on one page of print target image data. When, after the timing to start the inter-sheet process has come, the inter-sheet process ends or a predetermined time passes, the control portion 7 starts emitting laser light based on next one page of print target image data. For this reason, during a time period from when it is determined that a timing to start the inter-sheet process has come to when the inter-sheet process ends or the predetermined time passes, the control portion 7 determines in step S12 that the inter-sheet process is being executed (S12: Yes).

### Step S13

In step S13, the second image processing portion 52 of the control portion 7 executes a process of forming the detection toner images X11 to X14 in sequence on the intermediate transfer belt 26. Specifically, each time the step S13 is executed during execution of the normal image forming process by the first image processing portion 51, the second image processing portion 52 inputs detection image data corresponding to the detection toner images X11 to X14 to the image forming portion 3 in sequence. As shown in FIG. 5, this allows the image forming portion 3 to form the detection toner images X11 to X14 in the non-contact area A3 of the intermediate transfer belt 26 in sequence based on the detection image data. It is noted that the second image processing portion 52 does not execute step S13 while the inter-sheet process is executed (S12: Yes). As a result, as shown in FIG. 5, the detection toner images X11 to X14 are not formed on the intermediate transfer belt 26 while the inter-sheet process is executed.

### Step S14

In step S14, the detection processing portion 53 of the control portion 7 uses the detection portion 46 to detect densities and positions of the detection toner images X10 formed on the intermediate transfer belt 26 in the step S13, and stores the detected densities and positions in the storage portion 6. The densities and positions of the detection toner images X10 detected here are used in the image forming condition adjustment process described below.

### Step S15

In step S15, the control portion 7 determines whether or not the normal image forming process has ended. Specifically, the control portion 7 determines that the normal image forming process has ended when the last print image in the normal image forming process has been formed on the intermediate transfer belt 26 and the inter-sheet process has ended. When it is determined that the normal image forming process has ended (S15: Yes), the process moves to step S21, and when it is determined that the normal image forming process has not ended (S15: No), the process moves to step S16.

It is noted that in another embodiment, when the number of prints in the normal image forming process is equal to or less than 4 (four) that is the number of prints required to execute the detection image forming process, the control portion 7 may determine that the normal image forming process ends before the detection image forming process ends, and move the process to step S21 instead of executing the steps S14 to S15.

### Step S16

In step S16, the control portion 7 determines whether or not all the densities and positions of the detection toner images X11 to X14 formed in the step S13 have been detected. For example, the control portion 7 determines that all the densities and positions of the detection toner images X11 to X14 have been detected when the densities and positions of the same number of detection toner images X10 as a predetermined number of detection toner images X11 to X14 have been detected. In addition, the control portion 7 may determine that all the densities and positions of the detection toner images X11 to X14 have been detected when a predetermined time required to detect all the densities and positions of the detection toner images X11 to X14 has passed. When it is determined that all the densities and positions of the detection toner images X11 to X14 have been detected (S16: Yes), the process moves to step S17, and when it is determined that not all the densities and positions of the detection toner images X11 to X14 have been detected (S16: No), the process returns to step S12.

### Step S17

In step S17, the adjustment processing portion 55 of the control portion 7 executes the adjustment process to adjust the image forming condition in the image forming portion 3 based on the densities and positions of the detection toner images X11 to X14 detected in step S14. The adjustment made in the adjustment process of the step S17 is reflected in the normal image forming process and the detection image forming process executed after execution of the step S17. It is noted that as described above, the position shift correction process, the density correction process, and the like are executed in the adjustment process.

### Step S18

In step S18, as in the step S15, the control portion 7 determines whether or not the normal image forming process has ended. When it is determined that the normal image forming process has ended (S18: Yes), the condition adjustment process ends, and when it is determined that the normal image forming process has not ended (S18: No), the process returns to step S11.

Although the present embodiment presents an example case where the adjustment process is executed in step S17, the adjustment process may be executed at an arbitrary timing as far as it is executed after the densities and positions of the detection toner images X11 to X14 are detected in the step S14. For example, a part or all of the adjustment process may be executed between the step S14 and the step S15, or may be executed between the step S15 and the step S16.

As described above, when all the detection toner images X11 to X14 have been formed during execution of the normal image forming process, the condition adjustment process is executed before the normal image forming process ends.

### Step S21

On the other hand, in a case where, after the detection image forming process is started during execution of the normal image forming process, the normal image forming process ends before the detection image forming process ends (S16: No, S15: Yes), the process moves to step S21. In step S21, the second image processing portion 52 of the control portion 7 switches between continuing and not continuing the detection image forming process in accordance with a predetermined switch condition. Here, when it is determined to continue the detection image forming process (S21: Yes), the process moves to step S22, and when it is determined not to continue the detection image forming process (S21: No), the condition adjustment process ends together with the normal image forming process.

For example, in the initial setting of the image forming apparatus 100 or the like, the control portion 7 sets, in accordance with a user operation, whether or not to continue the detection image forming process in a case where the normal image forming process ends before the detection image forming process ends, and stores the setting in the storage portion 6. In the step S21, when the setting has been set to continue the detection image forming process in a case where the normal image forming process ends before the detection image forming process ends, it is determined to continue the detection image forming process (S21: Yes). That is, when the setting has been set not to continue the detection image forming process when the normal image forming process ends before the detection image forming process ends (S21: No), the detection image forming process ends midway when the normal image forming process ends. In this case, the setting by the user of whether or not to continue the detection image forming process is an example of a switch condition of the present disclosure.

In addition, in a case where the print target image data in the normal image forming process that is executed together with the condition adjustment process contains a photograph, image or the like that has a high coverage rate, it is highly possible that a photograph or an image is printed, too, in the normal image forming process that is executed next. As a result, in the step S21, the second image processing portion 52 may switch between continuing and not continuing the detection image forming process in accordance with the content of the print target image data. Specifically, in a case where the print target image data in the normal image forming process that is executed together with the condition adjustment process contains a photograph, an image or the like, the second image processing portion 52 may determine to continue the detection image forming process. On the other hand, in a case where the print target image data in the normal image forming process that is executed together with the condition adjustment process contains a text or the like, the second image processing portion 52 may determine, in the step S21, not to continue the detection image forming process. In this case, the content of the print target image data is an example of the switch condition of the present disclosure. It is noted that in a case where the print target image data in the normal image forming process that is to be executed next after the normal image forming process executed together with the condition adjustment process has been input, the second image processing portion 52 may switch between continuing and not continuing the detection image forming process in accordance with the content of the print target image data.

It is noted that in another embodiment, when it is determined not to continue the detection image forming process (S21: No), a non-execution flag may be set to 1. In addition, in the step S11, the control portion 7 may determine that the execution condition is satisfied when the non-execution flag is 1. With this configuration, even in a case where the detection image forming process ends before the execution of the normal image forming process, the detection image forming process and the adjustment process are executed when the next normal image forming process is executed, thereby suppressing the timing to improve the image quality from being delayed.

Further, in another embodiment, each time it is determined not to continue the detection image forming process (S21: No), a non-execution counter may be incremented by 1. The non-execution counter indicates the number of occurrences of an event in which the normal image forming process ends before the detection image forming process ends, and the detection image forming process is not continued after the normal image forming process ends. The non-execution counter is reset when the adjustment process is executed. In addition, in the step S21, the control portion 7 determines to continue the detection image forming process when the non-execution counter has reached a predetermined number. With this configuration, when an event in which the detection image forming process ends before the execution of the normal image forming process has occurred a predetermined number of times, the detection image forming process and the adjustment process are executed, thereby suppressing the timing to improve the image quality from being delayed. It is noted that when it is determined to continue the detection image forming process, the detection toner images X11 to X14 may be formed from the start in the detection image forming process.

### Step S22

In step S22, the second image processing portion 52 of the control portion 7 controls the image forming portion 3 such that the intermediate transfer belt 26, the image forming units 20 and the like continue to be driven even after the normal image forming process ends. This allows the intermediate transfer belt 26, the image forming units 20 and the like that are supposed to stop when the normal image forming process ends, to continue to be driven.

### Step S23

In step S23, the second image processing portion 52 of the control portion 7 determines whether or not it is within the inter-sheet period P0 in which the inter-sheet process is executed in a case where it is assumed that the normal image forming process is continuing. For example, the control portion 7 starts measuring time after it passes a timing to execute the inter-sheet process after image data corresponding to the last sheet in the normal image forming process is transferred to the intermediate transfer belt 26, and determines whether or not it is within the inter-sheet period P0 based on the measured time. Here, when it is determined that it is within the inter-sheet period P0 (S23: Yes), the process moves to step S25, and when it is determined that it is not within the inter-sheet period P0 (S23: No), the process moves to step S24.

### Step S24

In step S24, the second image processing portion 52 of the control portion 7 executes the detection image forming process continuing from step S13. For example, in a case where the detection toner image X11 for K (black) and the detection toner image X12 for C (cyan) have been formed on the intermediate transfer belt 26 in the step S13 in parallel with the normal image forming process for two pages, in the step S24, the second image processing portion 52 forms the detection toner image X13 for M (magenta) and the detection toner image X14 for Y (yellow) on the intermediate transfer belt 26 as a continuation. In addition, in a case where the detection toner image X11 for K (black), the detection toner image X12 for C (cyan), and the detection toner image X13 for M (magenta) have been formed on the intermediate transfer belt 26 in the step S13 in parallel with the normal image forming process for three pages, in the step S24, the second image processing portion 52 forms the detection toner image X14 for Y (yellow) on the intermediate transfer belt 26 as a continuation.

### Step S25

In step S25, as in step S14, the detection processing portion 53 of the control portion 7 uses the detection portion 46 to detect densities and positions of the detection toner images X10 that have been formed on the intermediate transfer belt 26 in the step S13, and stores the detected densities and positions in the storage portion 6.

### Step S26

In step S26, as in step S16, the detection processing portion 53 of the control portion 7 determines whether or not all the densities and positions of the detection toner images X11 to X14 have been detected. Here, when it is determined that all the densities and positions of the detection toner images X11 to X14 have been detected (S26: Yes), the process moves to step S27, and when it is determined that not all the densities and positions of the detection toner images X11 to X14 have been detected (S26: No), the process returns to step S23.

### Step S27

In step S27, the second image processing portion 52 of the control portion 7 controls the image forming portion 3 such that the intermediate transfer belt 26 and the image forming units 20 are stopped from being driven.

### Step S28

In step S28, the adjustment processing portion 55 of the control portion 7 executes the adjustment process for adjusting the image forming condition in the image forming portion 3 based on the densities and positions of the detection toner images X11 to X14 detected in step S14, step S25 and the like. It is noted that as described above, the position shift correction process, the density correction process, and the like are executed in the adjustment process.

As described above, in the image forming apparatus 100, it is possible to execute processing by switching between continuing and not continuing the detection image forming process in a case where the normal image forming process ends before the detection image forming process ends. With this configuration, in a case where the detection image forming process continues, it is possible to prevent the timing to improve the image quality from being delayed, and in a case where the detection image forming process does not continue, it is possible to suppress driving of the image forming apparatus 100 while the normal image forming process is not executed.

### Second Embodiment

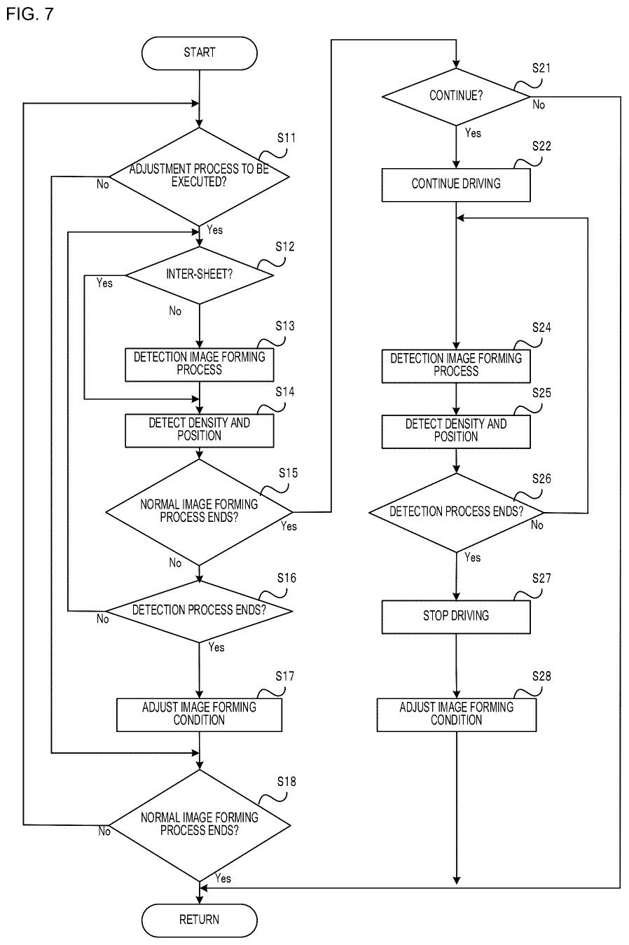

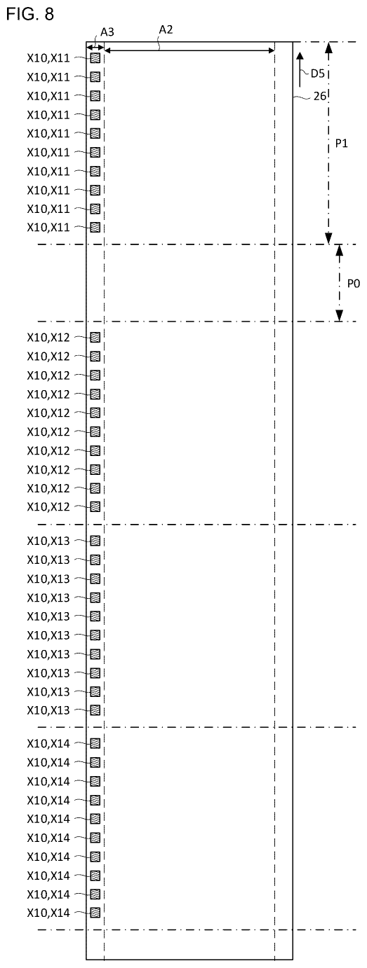

Next, another example of the condition adjustment process executed in an image forming apparatus according to a second embodiment is described with reference to FIG. 7 and FIG. 8. It is noted that configuration of the image forming apparatus 100 that is not described here is the same as that of the first embodiment.

As shown in FIG. 7, the step S23 is omitted in the condition adjustment process executed in the image forming apparatus 100 according to the present embodiment, and steps S24 to S25 are repeatedly executed until all the densities and positions of the detection toner images X11 to X14 are detected (S26: No). That is, although in the first embodiment, the process of forming the detection toner images X10 is suspended at a timing when the inter-sheet process is executed, in the condition adjustment process according to the present embodiment, the process of forming the detection toner images X10 continues to be executed without being suspended even during the inter-sheet period P0 in a case where it is assumed that the normal image forming process is continuing.

Specifically, FIG. 8 shows an example where the normal image forming process has ended after only an image based on one page of image data was formed in the print area P1 of the intermediate transfer belt 26 and all the detection toner images X11 were formed in the print area P1 of the intermediate transfer belt 26. In this case, as shown in FIG. 8, the remaining detection toner images X12 to X14 are formed on the intermediate transfer belt 26 in the step S24. At this time, when the detection toner images X12 to X14 are formed in the step S24, the process of forming the detection toner images X10 is not suspended at the timing when the inter-sheet process is executed, and thus the detection toner images X12 to X14 are formed in succession. This makes it possible to reduce the execution time of the detection image forming process.

### Third Embodiment

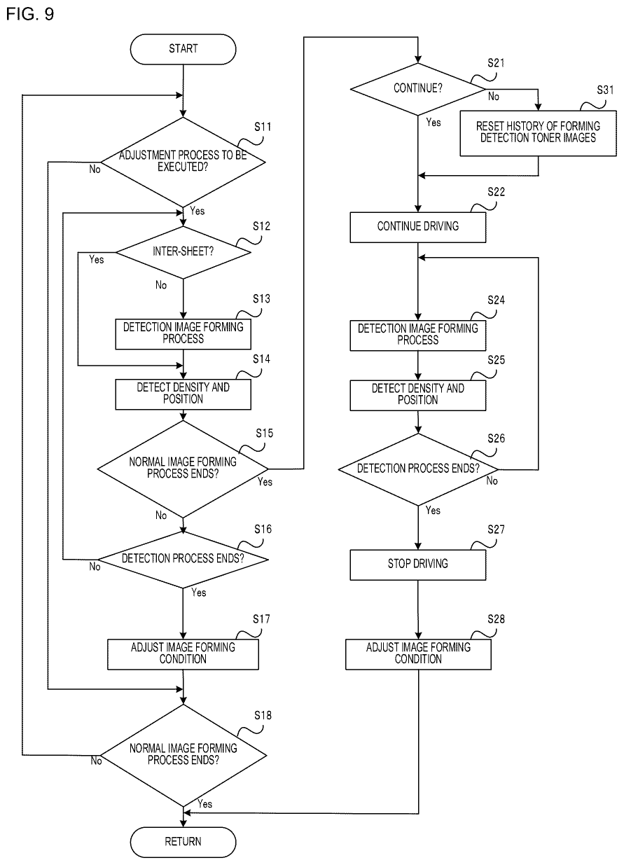

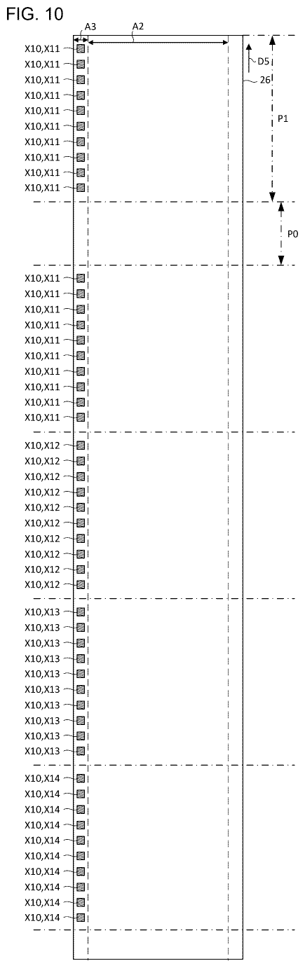

Next, another example of the condition adjustment process executed in an image forming apparatus according to a third embodiment is described with reference to FIG. 9 and FIG. 10. It is noted that configuration of the image forming apparatus 100 that is not described here is the same as that of the first embodiment.

As shown in FIG. 9, in the condition adjustment process executed in the image forming apparatus 100 according to the present embodiment, when, in the step S21, it is determined not to continue the detection image forming process (S21: No), the process moves to step S31.

### Step S31

In step S31, the second image processing portion 52 of the control portion 7 resets history of forming in the step S13 of the detection toner images X11 to X14. With this configuration, even in a case where only a part of the detection toner images X11 to X14 has been formed in the step S13, the detection toner images X11 to X14 are formed from the start in the step S24. In this way, in the condition adjustment process according to the present embodiment, in a case where the normal image forming process ends before the detection image forming process ends, the detection image forming process is executed from the start such that the detection toner images X11 to X14 are formed in the same condition, thereby increasing the accuracy of the adjustment process.

In addition, as is the case with the second embodiment, the step S23 is omitted in the condition adjustment process according to the present embodiment, too. As a result, steps S24 to S25 are repeatedly executed until all the densities and positions of the detection toner images X11 to X14 are detected (S26: No). That is, although in the first embodiment, the process of forming the detection toner images X10 is suspended at a timing when the inter-sheet process is executed, in the condition adjustment process according to the present embodiment, the process of forming the detection toner images X10 continues to be executed without being suspended even during the inter-sheet period P0 in a case where it is assumed that the normal image forming process is continuing.

Specifically, FIG. 10 shows an example where the normal image forming process has ended after only an image based on one page of image data was formed in the print area P1 of the intermediate transfer belt 26 and all the detection toner images X11 were formed in the print area P1 of the intermediate transfer belt 26. In this case, as shown in FIG. 10, the detection toner images X11 to X14 are formed from the start on the intermediate transfer belt 26 in the step S24. At this time, when the detection toner images X11 to X14 are formed in the step S24, the process of forming the detection toner images X10 is not suspended at the timing when the inter-sheet process is executed, and thus the detection toner images X11 to X14 are formed in succession. This makes it possible to reduce the execution time of the detection image forming process. It is noted that in another embodiment, the step S23 may not be omitted.

### Appended Notes on the Invention

The following notes are appended concerning a summary of the invention extracted from the above-described embodiments. It is noted that the configurations and processing functions explained in the following notes can be arbitrarily selected and combined.

### Note 1

An image forming apparatus comprising:
an image forming portion configured to form an image on a transfer object based on input image data;
a first image processing portion configured to execute a normal image forming process in which a print image is formed in a predetermined print area on the transfer object by the image forming portion based on print target image data; and
a second image processing portion configured to, when a predetermined execution condition is satisfied, execute a detection image forming process in which a detection image that is used for adjusting an image forming condition in the image forming portion, is formed by the image forming portion in an area outside the print area on the transfer object, wherein
in a case where, after the detection image forming process is started during execution of the normal image forming process, the normal image forming process ends before the detection image forming process ends, the second image processing portion switches between continuing and not continuing the detection image forming process in accordance with a predetermined switch condition.

### Note 2

The image forming apparatus according to Note 1, wherein
the second image processing portion
does not form the detection image on the transfer object during an inter-sheet period in which the print image is not formed on the transfer object in the normal image forming process, and
in a case where the detection image forming process is continued after the normal image forming process ends, does not form the detection image on the transfer object during the inter-sheet period in a case where it is assumed that the normal image forming process is continuing.

### Note 3

The image forming apparatus according to Note 1 or 2, wherein
the second image processing portion
does not form the detection image on the transfer object during an inter-sheet period in which the print image is not formed on the transfer object in the normal image forming process, and
in a case where the detection image forming process is continued after the normal image forming process ends, forms the detection image on the transfer object during the inter-sheet period in a case where it is assumed that the normal image forming process is continuing.

### Note 4

The image forming apparatus according to any one of Notes 1 to 3, wherein
in a case where the detection image forming process is not continued after the normal image forming process ends, the second image processing portion executes the detection image forming process again from a start after the normal image forming process ends.

### Note 5

The image forming apparatus according to Note 4, wherein
the second image processing portion
does not form the detection image on the transfer object during an inter-sheet period in which the print image is not formed on the transfer object in the normal image forming process, and
when executing the detection image forming process again from a start after the normal image forming process ends, forms the detection image on the transfer object during the inter-sheet period in a case where it is assumed that the normal image forming process is continuing.

### Note 6

The image forming apparatus according to any one of Notes 1 to 5, wherein
in a case where the normal image forming process ends before the detection image forming process ends, and the detection image forming process is not continued after the normal image forming process ends, the second image processing portion executes the detection image forming process when a next normal image forming process is executed.

### Note 7

The image forming apparatus according to any one of Notes 1 to 6, wherein
in a case where an event in which the normal image forming process ends before the detection image forming process ends, and the detection image forming process is not continued after the normal image forming process ends, has occurred a predetermined number of times continuously, the second image processing portion executes the detection image forming process after the normal image forming process ends.

### Note 8

The image forming apparatus according to any one of Notes 1 to 7, wherein
in a case where the normal image forming process ends before the detection image forming process ends, the second image processing portion switches between continuing and not continuing the detection image forming process in accordance with a setting set by a user operation.

### Note 9

The image forming apparatus according to any one of Notes 1 to 8, wherein
in a case where the normal image forming process ends before the detection image forming process ends, the second image processing portion switches between continuing and not continuing the detection image forming process in accordance with content of the print target image data.

### Note 10

An image forming method in which a processor of an image forming apparatus including an image forming portion configured to form an image on a transfer object based on input image data execute:
a first image processing step of executing a normal image forming process in which a print image is formed in a predetermined print area on the transfer object by the image forming portion based on print target image data; and
a second image processing step of, when a predetermined execution condition is satisfied, executing a detection image forming process in which a detection image that is used for adjusting an image forming condition in the image forming portion, is formed by the image forming portion in an area outside the print area on the transfer object, wherein
in the second image processing step, in a case where, after the detection image forming process is started during execution of the normal image forming process, the normal image forming process ends before the detection image forming process ends, switching is made between continuing and not continuing the detection image forming process in accordance with a predetermined switch condition.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image forming portion configured to form an image on a transfer object based on input image data;
a first image processing portion configured to execute a normal image forming process in which a print image is formed in a predetermined print area on the transfer object by the image forming portion based on print target image data; and
a second image processing portion configured to, when a predetermined execution condition is satisfied, execute a detection image forming process in which a detection image that is used for adjusting an image forming condition in the image forming portion, is formed by the image forming portion in an area outside the print area on the transfer object, wherein
in a case where, after the detection image forming process is started during execution of the normal image forming process, the normal image forming process ends before the detection image forming process ends, the second image processing portion switches between continuing and not continuing the detection image forming process in accordance with a predetermined switch condition.

2. The image forming apparatus according to claim 1, wherein
the second image processing portion
does not form the detection image on the transfer object during an inter-sheet period in which the print image is not formed on the transfer object in the normal image forming process, and
in a case where the detection image forming process is continued after the normal image forming process ends, does not form the detection image on the transfer object during the inter-sheet period in a case where it is assumed that the normal image forming process is continuing.

3. The image forming apparatus according to claim 1, wherein
the second image processing portion
does not form the detection image on the transfer object during an inter-sheet period in which the print image is not formed on the transfer object in the normal image forming process, and
in a case where the detection image forming process is continued after the normal image forming process ends, forms the detection image on the transfer object during the inter-sheet period in a case where it is assumed that the normal image forming process is continuing.

4. The image forming apparatus according to claim 1, wherein
in a case where the detection image forming process is not continued after the normal image forming process ends, the second image processing portion executes the detection image forming process again from a start after the normal image forming process ends.

5. The image forming apparatus according to claim 4, wherein
the second image processing portion
does not form the detection image on the transfer object during an inter-sheet period in which the print image is not formed on the transfer object in the normal image forming process, and
when executing the detection image forming process again from a start after the normal image forming process ends, forms the detection image on the transfer object during the inter-sheet period in a case where it is assumed that the normal image forming process is continuing.

6. The image forming apparatus according to claim 1, wherein
in a case where the normal image forming process ends before the detection image forming process ends, and the detection image forming process is not continued after the normal image forming process ends, the second image processing portion executes the detection image forming process when a next normal image forming process is executed.

7. The image forming apparatus according to claim 1, wherein
in a case where an event in which the normal image forming process ends before the detection image forming process ends, and the detection image forming process is not continued after the normal image forming process ends, has occurred a predetermined number of times continuously, the second image processing portion executes the detection image forming process after the normal image forming process ends.

8. The image forming apparatus according to claim 1, wherein
in a case where the normal image forming process ends before the detection image forming process ends, the second image processing portion switches between continuing and not continuing the detection image forming process in accordance with a setting set by a user operation.

9. The image forming apparatus according to claim 1, wherein
in a case where the normal image forming process ends before the detection image forming process ends, the second image processing portion switches between continuing and not continuing the detection image forming process in accordance with content of the print target image data.

10. An image forming method in which a processor of an image forming apparatus including an image forming portion configured to form an image on a transfer object based on input image data execute:
a first image processing step of executing a normal image forming process in which a print image is formed in a predetermined print area on the transfer object by the image forming portion based on print target image data; and
a second image processing step of, when a predetermined execution condition is satisfied, executing a detection image forming process in which a detection image that is used for adjusting an image forming condition in the image forming portion, is formed by the image forming portion in an area outside the print area on the transfer object, wherein
in the second image processing step, in a case where, after the detection image forming process is started during execution of the normal image forming process, the normal image forming process ends before the detection image forming process ends, switching is made between continuing and not continuing the detection image forming process in accordance with a predetermined switch condition.
